(19) United States
(12) Patent Application Publication
(10) Pub. No.: US 2013/0287273 A1
(43) Pub. Date: Oct. 31, 2013

(54) ANTI-MISOPERATION SYSTEM AND METHOD USING SAME

(71) Applicant: XIAN-ZENG HUANG, Shenzhen City (CN)

(72) Inventor: XIAN-ZENG HUANG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/564,766

(22) Filed: Aug. 2, 2012

(30) Foreign Application Priority Data
Apr. 26, 2012 (CN) 201210125608.8

(51) Int. Cl. G06K 9/62

(52) U.S. Cl. 382/124

(57) ABSTRACT

An anti-operation system in an electronic apparatus includes a detecting module, an identifying module, and a controlling module. The detecting module detects whether there is a touch-controlled program being activated and controls a pattern detection device to detect the detailed pattern of the object touching on the touch device. The identifying module verifies the pattern detected by the pattern detection device by reference to at least one predetermined fingerprint pattern. The controlling module determines whether an instruction apparently given should be acted upon or ignored according to a result of the verification made by the identifying module.

### TECHNICAL FIELD

The disclosure generally relates to error-reducing technologies for a touch panel, and particularly, to an anti-misoperation system and method.

### DESCRIPTION OF RELATED ART

Most touch panels are without a protective cover when not in use, hence an inadvertent touch on the touch panel may activate an operation of the electronic device, which may cause an unexpected loss to users.

Therefore, it is desirable to provide an anti-misoperation system and method which can overcome the above-mentioned problems.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an anti-misoperation system.

FIG. 2 is a flowchart of one embodiment of an anti-misoperation method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable median include CDs, DVDs, BLU-RAY, flash storages, and hard disk drives.

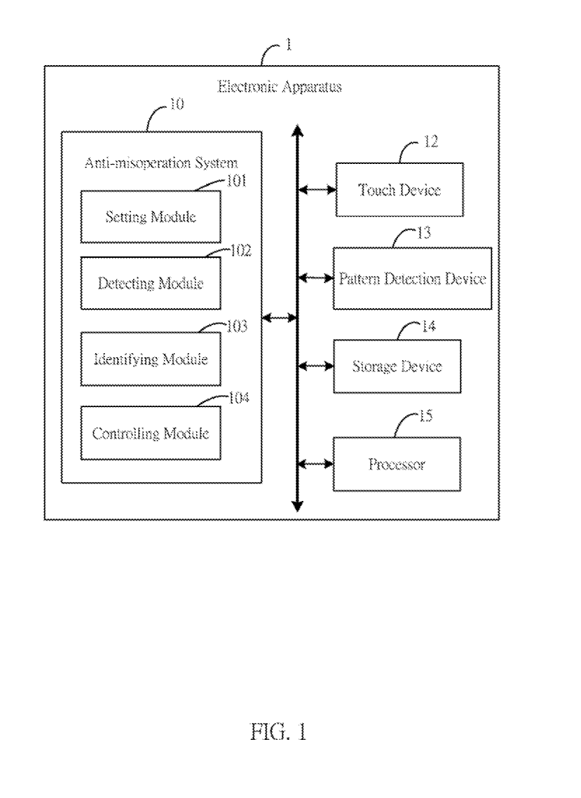

FIG. 1 is a block diagram of one embodiment of an anti-misoperation system 10 in an electronic apparatus 1. In one embodiment, the electronic apparatus 1 may include a touch device 12, a pattern detection device 13, at least one storage device 14, and at least one processor 15. The touch device 12, the pattern detection device 13, the storage device 14, and the processor 15 are directly or indirectly electrical connected for the exchange of data. In this embodiment, the electronic apparatus 1 may be, but is not limited to, a personal computer (PC), or a mobile intelligent terminal with a touch panel.

The touch device 12 senses a touch action of a user, generates an instruction corresponding to the touch action, and transmits the instruction to the processor 15. In this embodiment, the touch device 12 is a capacitive touch panel.

The pattern detection device 13 detects the detailed pattern of an object touching the touch device 12. For example, when a fingertip is touching the touch device 12, the pattern detection device 13 will detect a pattern of the fingerprint.

The storage device 14 may be, but is not limited to a hard disk, or a dedicated memory, such as an EPROM, HDD, or flash memory. The storage device 14 stores the patterns detected by the pattern detection device 13 and processes data generated during the operation of the anti-misoperation system 10.

The anti-misoperation system 10 includes a setting module 101, a detecting module 102, an identifying module 103, and a controlling module 104. The anti-misoperation system 10 can be embedded into an operating system of the electronic apparatus 1, or stored in the storage device 14 and executed by the processor 15.

The setting module 101 sets at least one fingerprint pattern. The fingerprint patterns may be, but is not limited to, a fingerprint of at least one finger of the user or a generic fingerprint pattern which has a number of generic features of the fingerprint. The generic fingerprint pattern can match most fingerprint. The setting module 101 also sets a security level of each program. The security level of the program includes a high level and a low level. If the security level of the program is high, this program only can be operated by an owner or administrator of the electronic apparatus 1. If the security of level of the program is low, this program can be operated by anybody.

The detecting module 102 detects whether a program needing to be controlled by a touch action is activated, and if so controls the pattern detection device 13 to detect the pattern of the object touching the touch device 12. When the program subject to touch control is activated, the touch device 12 displays a number of touch areas corresponding to different processes or options of the activated program. The user touches one of the touch areas to direct the activated program as desired. For example, when the electronic apparatus 1 receives a calling request, a communication program will be activated. The touch device 12 displays an “answer” touch area to represent acceptance of the call and a “refuse” touch area to represent a rejection or refusal of the call. If the user touches the “answer” touch area, the communication program establishes a communication connection. If the user touches the “refuse” touch area, the communication program refuses the calling request. The pattern detection device 13 further detects the physical pattern of the object touching the touch area when the touch controlled program is activated. The detected patterns are stored in the storage device 14.

The identifying module 103 verifies the detected pattern on the touch area by matching it with the at least one predetermined fingerprint pattern. If the detected pattern matches with the at least one predetermined fingerprint pattern, the identifying module 103 transmits a positive instruction to the controlling module 104. If the detected pattern does not match with the at least one predetermined fingerprint pattern, the identifying module 103 transmits a negative instruction to the controlling module 104.

If the generic fingerprint pattern is used as the verification model for the detected pattern, any fingerprint will be considered as matching with the fingerprint pattern. Whether the generic fingerprint pattern is chosen as the verification model for the detected pattern is determined by the security level of the activated program. If the security level of the activated program is high, the generic fingerprint pattern is prohibited as a verification model. If the security level of the activated program is low, the generic fingerprint pattern is allowed for verification of the detected pattern. The user can assign the generic fingerprint pattern and make it available to several predetermined programs. Thus, when one of these predetermined programs is activated, the generic fingerprint pattern is allowed after verification of the detected pattern of the touching object so as to activate the predetermined program.

The controlling module 104 determines whether to execute an instruction activated by the current touch according to the result of the verification made by the identifying module 103. If the detected pattern of the touching object matches one of the predetermined fingerprint patterns, the touch action is considered as made by a human fingertip, and is not considered as a misoperation or error caused by a collision or contact with another object. Thus, the controlling module 104 executes the instruction activated by the current touch. If the detected pattern of the touching object does not match with one of the predetermined fingerprint patterns, the touch action is considered as an error or misoperation. Thus, the controlling module 104 will ignore the instruction activated by the current non-matching touch.

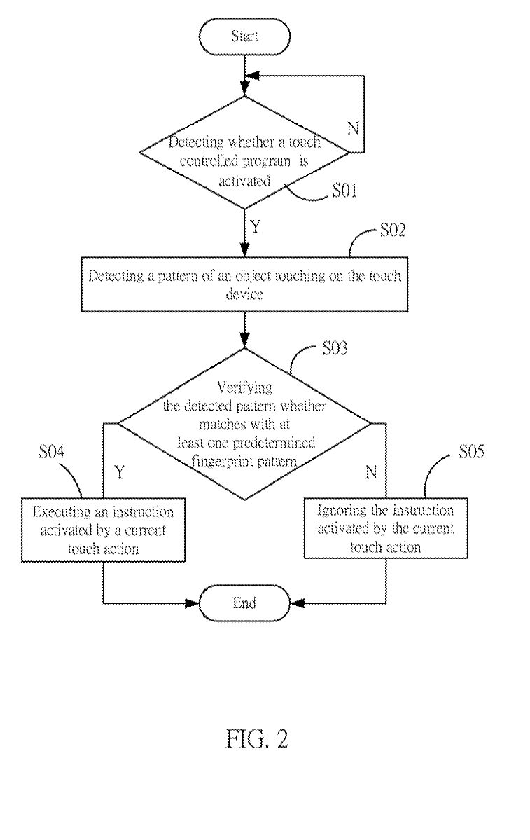

FIG. 2 is a flowchart of one embodiment of an anti-misoperation method to automatically avoid responding to the inadvertent touch. Depending on the embodiment, additional steps may be added, others deleted, and the ordering of the steps may be changed.

In step S01, the detecting module 102 detects whether a touch controlled program is activated.

In step S02, when the touch controlled program is activated, the detecting module 102 controls the pattern detection device 13 to detect the detailed pattern of the object touching specific areas of the touch device 12 and stores the detected pattern in the storage device 14.

In step S03, the identifying module 103 verifies the detected pattern according to at least one predetermined fingerprint pattern.

In step S04, if the detected pattern matches with the at least one predetermined fingerprint pattern, the identifying module 103 transmits the positive instruction to the controlling module 104. The controlling module 104 executes the instruction intended by the current touch.

In step S05, if the detected pattern does not match with the at least one predetermined fingerprint pattern, the identifying module 103 transmits the negative instruction to the controlling module 104. The controlling module 104 ignores the current touch.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An anti-misoperation system operated in an electronic apparatus, the electronic apparatus comprising a touch device for sensing a touch action and generating an instruction corresponding to the touch action, and a pattern detection device for detecting a pattern of an object touching on the touch device, the anti-misoperation system comprising:
a detecting module that detects whether there is a program needed to be controlled by a touch action is activated, and controls the pattern detection device to detect the pattern of the object touching on the touch device when the touch controlled program is activated;
an identifying module that verifies that the pattern detected by the pattern detection device matches with at least one predetermined fingerprint pattern; and
a controlling module that executes an instruction activated by the current touch action according to a result of the verification made by the identifying module.

2. The anti-misoperation system of claim 1, wherein the anti-misoperation system further comprises a setting module that sets the at least one predetermined fingerprint pattern.

3. The anti-misoperation system of claim 2, wherein the at least one predetermined fingerprint pattern comprises a fingerprint of at least one fingertip of a user.

4. The anti-misoperation system of claim 2, wherein the at least one predetermined fingerprint pattern comprises a generic fingerprint pattern, the generic fingerprint pattern has a plurality of generic features of the fingerprint and is operable to match most fingerprint.

5. The anti-misoperation system of claim 2, wherein the setting module is further configured to set a security level of each program, the security level of the program comprises a high level and a low level, if the security level of the program is high, this program is only operated by a particular user of the electronic apparatus, if the security level of the program is low, this program is operated by everybody access to the electronic apparatus.

6. The anti-misoperation system claim 1, wherein if the detected pattern matches with the at least one predetermined pattern, the identifying module transmits a positive instruction to the controlling module; if the detected pattern does not match with the at least one predetermined fingerprint patterns, the identifying module transmits a negative instruction to the controlling module.

7. The anti-misoperation system of claim 6, wherein the controlling module executes the instruction activated by the current touch action when receiving the positive instruction from the identifying module, the controlling module ignores the instruction activated by the current touch action when receiving the negative instruction from the identifying module.

8. An anti-misoperation method being performed by execution of computer readable program code by a processer of an electronic apparatus presetting at least one predetermined fingerprint pattern, the electronic apparatus comprising a touch device to sense a touch action, the method comprising:
detecting whether there is a program needed to be controlled by the touch action is activated;
detecting a pattern of an object touching on the touch device when the touch controlled program is activated;
verifying the detected pattern matches with the at least one predetermined fingerprint pattern;
executing an instruction activated by a current touch action if the detected pattern matches with the at least one predetermined fingerprint pattern.

9. The method as claimed in claim 8, further comprising:
ignoring the instruction activated by the current touch action if the detected pattern does not match with the at least one predetermined fingerprint pattern,.

10. The method as claimed in claim 8, wherein the at least one predetermined fingerprint pattern comprises a fingerprint of at least one fingertip of a user.

11. The method as claimed in claim 8, wherein the at least one predetermined fingerprint pattern comprises a generic fingerprint pattern, the generic fingerprint pattern has a plurality of generic features of the fingerprint and is operable to match with most fingerprint.

12. The method as claimed in claim 8, wherein the electronic apparatus presets a security level to each program, the security level of the program comprises a high level and a low level, and if the security level of the program is high, the program is only operated by a particular user of the electronic apparatus; if the security level of the program is low, the program is operated by everybody access to the electronic apparatus.
